(19) United States
(12) Patent Application Publication
(10) Pub. No.: US 2022/0048932 A1
(43) Pub. Date: Feb. 17, 2022

(54) PROCESS FOR CONTINUOUS PURIFICATION OF HIGH-PURITY TRIMETHYLALUMINUM

(71) Applicant: Anhui Botai Electronic Materials Co., Ltd., Chuzhou City (CN)

(72) Inventors: Fuquan SONG, Chuzhou City (CN); Zhiguo LU, Chuzhou City (CN); Yanhui SUN, Chuzhou City (CN); Changli SUN, Chuzhou City (CN); Fengyu YANG, Chuzhou City (CN)

(21) Appl. No.: 17/243,083

(22) Filed: Apr. 28, 2021

(30) Foreign Application Priority Data
Aug. 12, 2020 (CN) 202010804927.6

(51) Int. Cl. C07F 5/06; B01D 61/36

(52) U.S. Cl. CPC C07F 5/062; B01D 61/366; B01D 61/364; B01D 2313/22; B01D 2311/25; B01D 2313/125; B01D 2313/90; B01D 2313/10; B01D 2311/10; B01D 2313/08

(57) ABSTRACT

A process for continuous purification of high-purity trimethylaluminum is provided. The process includes preparing a membrane separator, which is placed vertically for use, and arranging a condenser tube inside of the membrane separator and a heating tube outside of the membrane separator, and a disperser at the top of the membrane separator for dispersing a liquid. The liquid naturally flows down along the inner wall of the heating tube by gravity to form a membrane. The process further includes concentrating liquid components having a low boiling point which are collected by the condenser at different stages and concentrating liquid components having a high boiling point which are collected by the heating wall.

### CROSS REFERENCE TO RELATED APPLICATION

This application—claims priority under 35 U.S.C. § 119(b) to Chinese Application No. 202010804927.6, filed Aug. 12, 2020, the disclosure of which is incorporated herein by reference in its entirety.

### TECHNICAL FIELD

The present disclosure relates to the technical field of chemical production, and in particular to a process for continuous purification of high-purity trimethylaluminum.

### BACKGROUND OF THE INVENTION

High-purity trimethylaluminum is a precursor material in the deposition of ALD (atomic vapor deposition) or CVD (chemical vapor deposition). The contents of impurity metals, silicon, oxygen and organic matters in the trimethylaluminum raw material are important indexes for high-purity trimethylaluminum product. Among others, exceeding standard amount of the impurity plays a crucial influence on the photoelectric performance of the chip produced by the deposition process. The high-purity trimethylaluminum generally requires a purity of 99.999% (5N, photovoltaic cells) and 99.9999% (6N, integrated circuits and LED chips).

The process for purification of high-purity trimethylaluminum is a route for physical separation that meets the requirements of CVD and ALD. There are many patents related to the process for purification of high-purity trimethylaluminum at present. Patents CN1749260A, CN109553632A, and CN109569003A reported that according to the principle that different components with different boiling point have different retention time in the different distillation column, trimethylaluminum was separated from impurities by distillation column at atmospheric pressure. CN104774218A reported that an adduct was firstly prepared by trimethylaluminum and ether, and the trimethylaluminum-ether adduct was purified by a chromatography column with a silica gel, and then the resulting purified adduct was heated and decomposed to remove the ether ligand, to obtain high-purity trimethylaluminum. The processes for purification of trimethylaluminum reported above, however, are batch purification processes, which as a whole include many steps, have a large liquid holdup in the purification process, and have a high risk and high safety vulnerabilities. For this reason, the present applicant propose a process for continuous purification of high-purity trimethylaluminum.

### BRIEF SUMMARY OF THE INVENTION

An objective of the present disclosure is to provide a process for continuous purification of high-purity trimethylaluminum, to solve the problems in the prior art of complicated process, large liquid holdup, and high risk and high safety vulnerabilities for high dangerousness products.

In order to achieve the above objective, the present disclosure provides the following technical solutions:

A process for continuous purification of high-purity trimethylaluminum, comprising,

S1: preparing a membrane separator, which is placed vertically for use, and arranging a condenser tube inside and a heating tube outside the membrane separator, and a disperser at the top of the membrane separator for dispersing a liquid, the liquid naturally flowing down along the inner wall of the heating tube by gravity to form a membrane, and concentrating liquid components with low boiling point which collected by the condenser at different stages and concentrating liquid components with high boiling point which collected by the heating wall;

S2: arranging a number of fraction collection outlets O₁ to Oₓ at different positions of the membrane separator, wherein the liquid collected from the outlets O₁ to Oₓ contains more components with low boiling point, and

arranging a number of fraction collection outlets Oₓ₊₁ to Oₓ₊ₙ in the middle of membrane separator for collecting a mixed liquor, and returning the mixed liquor collected from the outlets Oₓ₊₁ to Oₓ₊ₙ to a crude trimethylaluminum tank for subsequent separation;

S3: arranging a number of high-purity product collection outlets Oₚ₁ to Oₚₙ in the lower part of membrane separator and a residual liquid collection outlet O_{W} at the bottom of the membrane separator, wherein the liquid collected from the outlets Oₚ₁ to O_{Pn} is a qualified product, the residual liquid is collected from the collection outlet O_{w}, and

arranging a sample collection outlet on each of the collection outlets for sampling and analysis;

S4: according to the sampling and analysis results from the sample collection outlet, classifying the collection outlets as the fraction collection outlets, the mixed liquid collection outlets and the qualified product collection outlets; and

S5: charging hot oil and cold oil into the membrane separator, keeping temperatures of hot oil and cold oil each be constant at a fixed value so that the temperature accuracy is controlled at ±1° C., wherein the temperature of hot oil ranges from 40° C. to 80° C., and the temperature of cold oil ranges from 5° C. to 20° C.

In some embodiments, the membrane separator is provided with a condensing medium inlet at its bottom, and with a cold medium outlet at its right side of the top.

In some embodiments, the membrane separator is provided with a hot medium inlet at its right side of the bottom, and with a hot medium outlet at the right side of the top.

In some embodiments, the top of the membrane separator is connected to a micro metering pump through a pipe, and the micro metering pump is connected to the crude trimethylaluminum tank through a pipe.

In some embodiments, the membrane separator is provided with a liquid disperser at its top. The trimethylaluminum product in the form of liquid is fed into the separator through a pipe connected with the micro metering pump, and then dispersed into the inner wall of the heating tube to naturally flow down by gravity to form a membrane.

In some embodiments, the membrane separator is connected with a front fraction storage tank, a high-purity product storage tank and a residual liquid storage tank through a pipe, at its one side, respectively.

Compared with the prior art, the present disclosure has the following beneficial effects:

1. In the present disclosure, a continuous purifier is used to purify trimethylaluminum, making it possible to improve the production efficiency of the product and being easy for operation; once the purifier turns on normally, it could be carried out continuously;

2. The trimethylaluminum product is purified in a sub-boiling state; specifically, the trimethylaluminum product is purified under the conditions of a low process temperature and in a state lowing than a boiling point;

3. The liquid holdup is small during the purification process, which reduces safety risk and safety vulnerabilities.

### BRIEF DESCRIPTION OF THE DRAWING

The foregoing summary, as well as the following detailed description of the preferred invention, will be better understood when read in conjunction with the appended drawing. For the purpose of illustrating the preferred invention, there is shown in the drawing an embodiment which is presently preferred. It should be understood, however, that the invention is not limited to the precise arrangements and instrumentalities shown. In the drawing:

FIG. 1 shows a schematic diagram of the process for continuous purification of high-purity trimethylaluminum according to an embodiment of the present disclosure.

### DETAILED DESCRIPTION OF THE INVENTION

In the following, the technical solutions in the embodiments of the present disclosure will be clearly and completely described in combination with the drawings. Obviously, the examples as described are only a part of the examples of the present disclosure, not all of them.

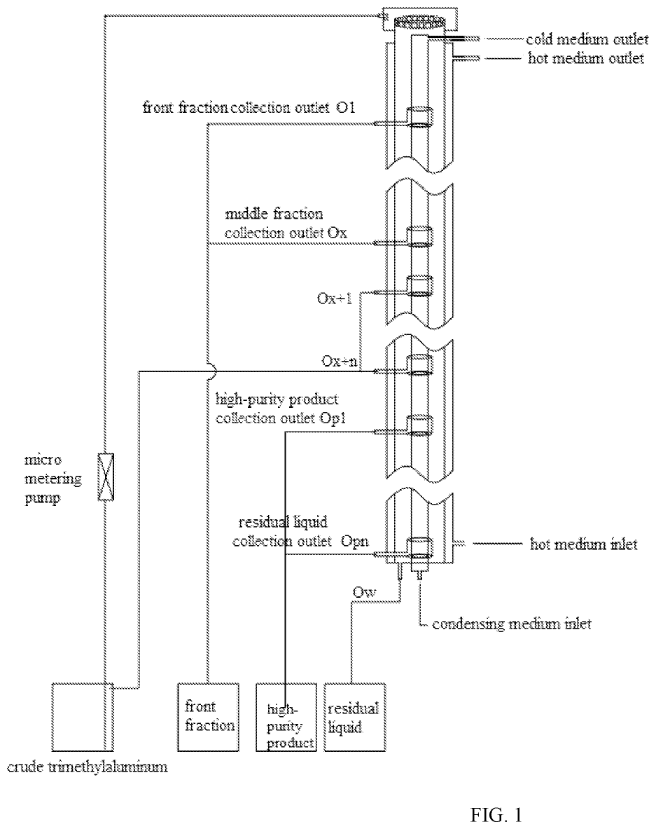

Referring to the FIG. 1, a process for continuous purification of high-purity trimethylaluminum includes:

S1: preparing a membrane separator, which is placed vertically for use, and arranging a condenser tube inside and a heating tube outside the membrane separator, and a disperser at the top of the membrane separator for dispersing a liquid, the liquid naturally flowing down along the inner wall of the heating tube by gravity to form a membrane, and concentrating liquid components with low boiling point which collected by the condenser at different stages and concentrating liquid components with high boiling point which collected by the heating wall;

S2: arranging a number of fraction collection outlets O₁ to Oₓ at different positions of the membrane separator, wherein the liquid collected from the outlets O₁ to Oₓ contains more components with low boiling point, and

arranging a number of fraction collection outlets Oₓ₊₁ to Oₓ₊ₙ in the middle of membrane separator for collecting a mixed liquid, and returning the mixed liquid collected from the outlets Oₓ₊₁ to Oₓ₊ₙ to a crude trimethylaluminum tank for subsequent separation;

S3, arranging a number of high-purity product collection outlets Oₚ₁ to Oₚₙ in the lower part of membrane separator and a residual liquid collection outlet O_{W} at the bottom of the membrane separator, wherein the liquid collected from the outlets Oₚ₁ to O_{Pn} is a qualified product, the residual liquid is collected from the collection outlet O_{w}, and

arranging a sample collection outlet on each of the collection outlets for sampling and analysis;

S4: according to the sampling and analysis results from the sample collection outlet, classifying the collection outlets as the fraction collection outlets, the mixed liquid collection outlets and the qualified product collection outlets; and

S5: charging hot oil and cold oil into the membrane separator, keeping temperatures of hot oil and cold oil each be constant at a fixed value so that the temperature accuracy is controlled at ±1° C., wherein the temperature of hot oil ranges from 40° C. to 80° C., and the temperature of cold oil ranges from 5° C. to 20° C.

In this example, the membrane separator is provided with a condensing medium inlet at its bottom, and with a cold medium outlet at its right side of the top.

In this example, the membrane separator is provided with a hot medium inlet at its right side of the bottom, and with a hot medium outlet at the right side of the top.

In this example, the top of the membrane separator is connected to a micro metering pump through a pipe; and the micro metering pump is connected to the crude trimethylaluminum tank through a pipe.

In this example, the membrane separator is provided with a liquid disperser at its top; the trimethylaluminum product in the form of liquid is fed into the separator through a pipe connected with the micro metering pump, and then dispersed into the inner wall of the heating tube to naturally flow down by gravity to form a membrane.

In this example, the membrane separator is connected with a fraction storage tank, a high-purity product storage tank and a residual liquid storage tank through a pipe, at its one side, respectively.

The working principle of the present disclosure is described as follows:

A membrane separator is placed vertically for use; the membrane separator is provided with a condenser tube inside and a heating tube outside, and with a disperser at its top for dispersing a liquid, wherein the liquid naturally flows down along the inner wall of the heating tube by gravity to form a membrane, and liquid components with low boiling point which collected by the condenser at different stages are concentrated and liquid components with high boiling point which collected by the heating wall are concentrated;

the membrane separator is provided with high-purity product collection outlets Oₚ₁ and Oₚₙ and a residual liquid collection outlet O_{W}, wherein the liquid collected from the outlets Oₚ₁ to Oₚₙ is a qualified product, and the residue liquid with high boiling point is collected from the collection outlet O_{w}; a sample collection outlet is arranged on each of the collection outlets for sampling and analysis;

the membrane separator is provided with a number of fraction collection outlets O₁ to Oₓ at its different positions, wherein the liquid collected from the outlets O₁ to Oₓ contains more components with low boiling point;

the membrane separator is provided with a number of fraction collection outlets Oₓ₊₁ to Oₓ₊ₙ for collecting a mixed liquid, and the mixed liquid collected from the outlets Oₓ₊₁ to Oₓ₊ₙ is returned to a crude trimethylaluminum tank for subsequent separation.

Moreover, in the present disclosure, a continuous purifier is used to purify trimethylaluminum, making it possible to improve the production efficiency of the product and being easy for operation; once the purifier turns on normally, it could be carried out continuously. The trimethylaluminum product is purified in a sub-boiling state, specifically under the conditions of a low process temperature and in a state lowing than a boiling point. The liquid holdup is small during the purification process, which reduces safety risk and safety vulnerabilities.

The principle of the process of the present disclosure is not only limited to the purification of trimethylaluminum, but also suitable for the purification of various liquid compounds. According to the different physical properties of materials, it is only needed to change the temperature range of the hot medium and the cold medium used in the process.

It will be appreciated by those skilled in the art that changes could be made to the embodiment described above without departing from the broad inventive concept thereof. It is understood, therefore, that this invention is not limited to the particular embodiments disclosed, but it is intended to cover modifications within the spirit and scope of the present invention as defined by the appended claims.

1. A process for continuous purification of high-purity trimethylaluminum, comprising,
S1: preparing a membrane separator, which is placed vertically for use, and arranging a condenser tube inside of the membrane separator and a heating tube outside of the membrane separator, and a disperser at a top of the membrane separator for dispersing a liquid, the liquid naturally flowing down along an inner wall of the heating tube by gravity to form a membrane, and concentrating liquid components having a low boiling point which are collected by the condenser at different stages and concentrating liquid components having a high boiling point which are collected by the inner wall;
S2: arranging a number of fraction collection outlets O₁ to Oₓ at different positions of the membrane separator, wherein liquid collected from the outlets O₁ to Oₓ contains more components having a low boiling point, and
arranging number of fraction collection outlets Oₓ₊₁ to Oₓ₊ₙ in a middle of the membrane separator for collecting a mixed liquid, and returning the mixed liquid collected from the outlets Oₓ₊₁ to Oₓ₊ₙ to a crude trimethylaluminum tank for subsequent separation;
S3: arranging a number of high-purity product collection outlets Oₚ₁ to Oₚₙ in a lower part of the membrane separator and a residual liquid collection outlet O_{W} at a bottom of the membrane separator, wherein liquid collected from the outlets Oₚ₁ to O_{Pn} is a qualified product, and the residual liquid is collected from the collection outlet O_{w}, and
arranging a sample collection outlet on each of the collection outlets for sampling and analysis;
S4: according to the sampling and analysis results from the sample collection outlet, classifying the collection outlets as the fraction collection outlets, the mixed liquid collection outlets and [[the]] qualified product collection outlets; and
S5: charging hot oil and cold oil into the membrane separator, keeping temperatures of the hot oil and the cold oil each be constant at a fixed value so that the temperature accuracy is controlled at ±1° C., wherein the temperature of the hot oil ranges from 40° C. to 80° C., and the temperature of the cold oil ranges from 5° C. to 20° C.

2. The process as claimed in claim 1, wherein the membrane separator is provided with a condensing medium inlet at its bottom, and with a cold medium outlet at its right side of the top.

3. The process as claimed in claim 1, wherein the membrane separator is provided a hot medium inlet at its right side of the bottom, and with a hot medium outlet at its right side of the top.

4. The process as claimed in claim 1, wherein the top of the membrane separator is connected to a micro metering pump through a pipe, and the micro metering pump is connected to the crude trimethylaluminum tank through a pipe.

5. The process as claimed in claim 1, wherein the membrane separator is provided with a liquid disperser at its top, and the trimethylaluminum product in the form of liquid is fed into the membrane separator through a pipe connected with the micro metering pump, and then dispersed into the inner wall of the heating tube to naturally flow down along by gravity to form a membrane.

6. The process as claimed in claim 1, wherein the membrane separator is, at its one side, connected with a fraction storage tank, a high-purity product storage tank and a residual liquid storage tank through a pipe, respectively.
